(19) United States
(12) Patent Application Publication
(10) Pub. No.: US 2015/0363371 A1
(43) Pub. Date: Dec. 17, 2015

(54) SYSTEM AND METHOD FOR ADAPTIVE USER INTERFACE SCALING

(71) Applicant: Siemens Product Lifecycle Management Software Inc., Plano, TX (US)

(72) Inventors: Siarhei Sadouski, Irvine, CA (US); Michael Brown, Lakewood, CA (US); Daniel Sicking, Lakewood, CA (US); Dick Baardse, Geldermalsen (NL)

(21) Appl. No.: 14/496,722

(22) Filed: Sep. 25, 2014

Related U.S. Application Data
(60) Provisional application No. 62/012,279, filed on Jun. 14, 2014.

(51) Int. Cl. G06F 17/22; G06F 3/0484

(52) U.S. Cl. CPC G06F 17/2288; G06F 3/04847; G06F 17/2205; G06F 17/2247

(57) ABSTRACT

Methods for displaying user interface (UI) elements in a data processing system and corresponding systems and computer-readable mediums. A method includes executing an application by the data processing system. The method includes receiving stored UI configuration information and displaying at least one UI element by the data processing system and in the application according to the UI configuration information.

### CROSS-REFERENCE TO OTHER APPLICATION

This application claims the benefit of the filing date of U.S. Provisional Patent Application 62/012,279, filed Jun. 14, 2014, for “System and Method for Touch Screen Ribbon Interaction,” which is hereby incorporated by reference.

### TECHNICAL FIELD

The present disclosure is related to interacting with a touch screen computer program, including, but not limited to, those directed to computer-aided design, visualization, and manufacturing systems (“CAD/CAM systems”), product lifecycle management (“PLM”) systems, and similar systems, that manage data for products and other items (collectively, “Product Data Management” systems or PDM systems).

### BACKGROUND OF THE DISCLOSURE

Interface options exist inside operating systems which let users increase text or icon sizes throughout the whole system. However, such changes fail to satisfy better user interface (UI) interactivity on computer displays, including but not limited to reduced-size computer display devices, mobile phones, smart phones, mobile devices, tablets, laptops, etc., including those that include touch screen or 4K monitors. For example, some elements in the UI do not use text or icons and cannot honor system settings altering the text or icon sizes. It is also a problem that system settings scale every UI element equally regardless of their priority or place in UI layouts. Improved systems are desirable.

### SUMMARY OF THE DISCLOSURE

Disclosed embodiments include methods for displaying user interface (UI) elements in a data processing system and corresponding systems and computer-readable mediums. A method includes executing an application by a data processing system. The method includes receiving stored UI configuration information and displaying at least one UI element by the data processing system and in the application according to the UI configuration information.

Various disclosed embodiments include systems and methods for adapting a UI in computer display devices, including but not limited to, reduced-size computer display devices, mobile phones, smart phones, mobile devices, tablets, laptops, etc. The systems and methods include controlling UI elements' size by honoring additional factor attributes, including but not limited to margins, size, and scale provided via an adaptive UI scaling system, also known as touch scheme in XML format (hereafter “TSX format”). Disclosed embodiments do not require an increase in text size so as to make other UI elements bigger in the event that text is already at a readable size level. The flexibility of the embodiments disclosed herein allows adjusting UI element size independently and per need.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates an exemplary UI without TSX format applied and also illustrates the interactive editing capabilities of each UI element in accordance with disclosed embodiments.

FIG. 3 illustrates an exemplary embodiment of a UI that corresponds to the UI illustrated in FIG. 2, but with TSX applied in accordance with disclosed embodiments;

FIG. 4 illustrates some elements of a data processing system that can implement disclosed embodiments; and

FIG. 5 illustrates a flowchart of a process in accordance with disclosed embodiments.

### DETAILED DESCRIPTION

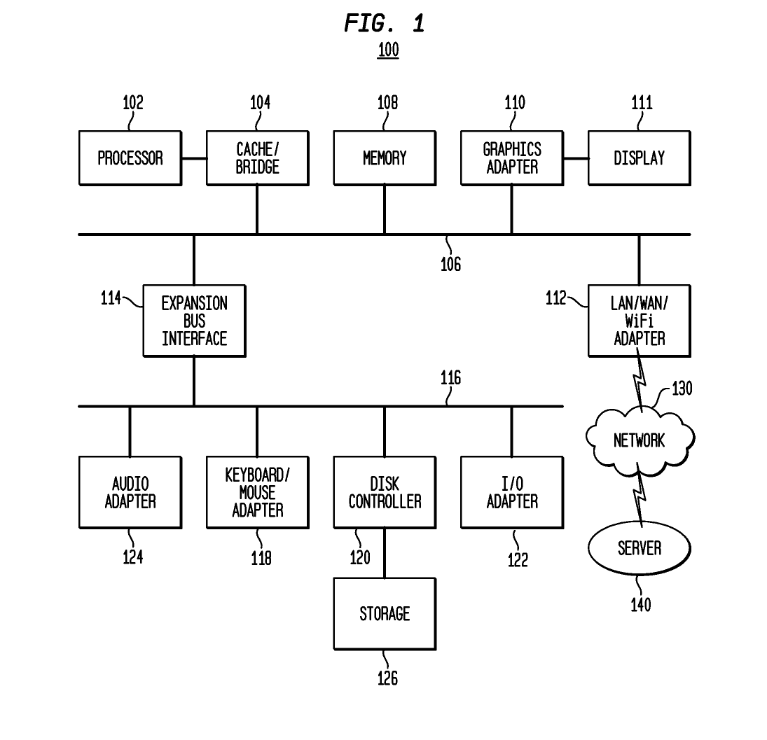

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Some user interface options inside operating systems can allow user increase text or icon sizes throughout the whole system. In many cases, this can help the users to adjust the system to their needs.

Some systems cannot properly adapt to such changes. For example, many applications executing in a MICROSOFT WINDOWS® operating system environment do not properly manage such scaling, and such changes are not enough to satisfy better user interface (UI) interactivity on touch devices or with 4K monitors. Many elements in such a user interface do not use text or icons and thus could not honor system settings. It is also a problem that system settings may scale every UI element equally regardless their priority or place in UI layouts.

FIG. 1 illustrates a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, touchpad, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

To address scaling issues described above, disclosed embodiments can control user interface elements size by honoring additional margins, size, and scale factor attributes provided via adaptive UI scaling processes that implement a touch scheme in XML format. With this system there is no need to increase text size just to make UI elements bigger in the event that text is already at a readable size level. The flexibility of TSX format allows adjusting UI element size independently and per need.

Disclosed embodiments can manage the size of UI elements according to physical or virtual screen dimensions. The disclosed TSX format can include identifiers for UI elements. Each of these identifiers can be associated with one or more parameters or attributes that can be further honored by UI element layout code in achieving specific UI element visuals and sizes. For example, an embodiment of TSX format uses an XML formatted file for storing and retrieving UI element scale attributes; the file can be extended with other parameters due to the flexible nature of XML data organization.

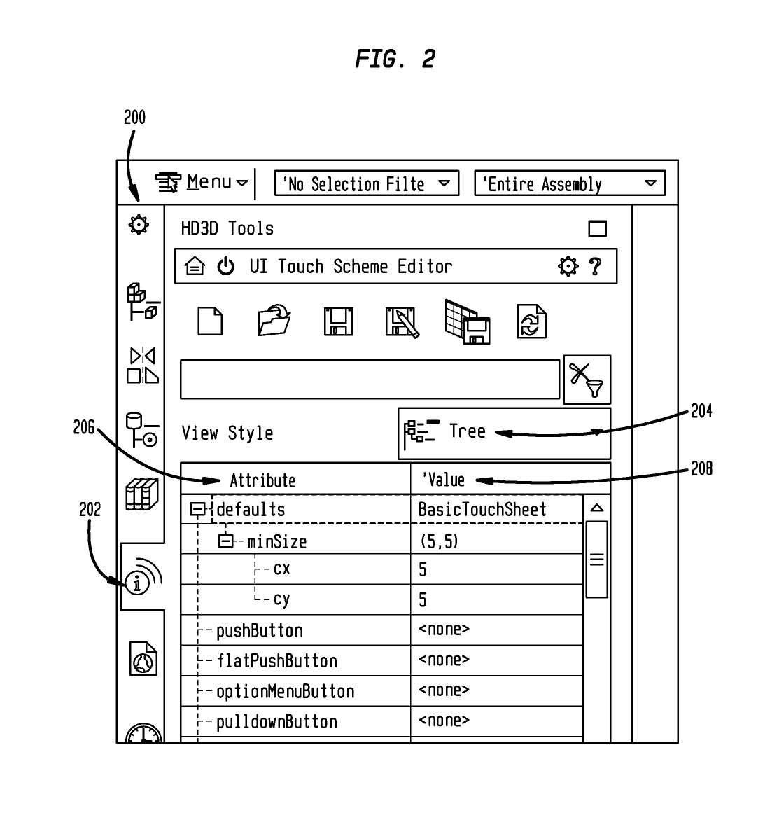

FIG. 2 illustrates an exemplary UI 200 without TSX format applied. FIG. 2 also illustrates the interactive editing capabilities of each UI element. For example, UI element 202 is to be displayed as a tree style 204. Each element has one or more attributes 206, each of which may have a corresponding value 208 to form attribute/value pairs. Note, in this example, the “minSize” attribute shows a minimum height (cy) and width (cx) for the default entries in the tree view. UI 200 shows an example of a user interface that can be used to configure UI element attribute settings by receiving such configuration information via an interaction with a user.

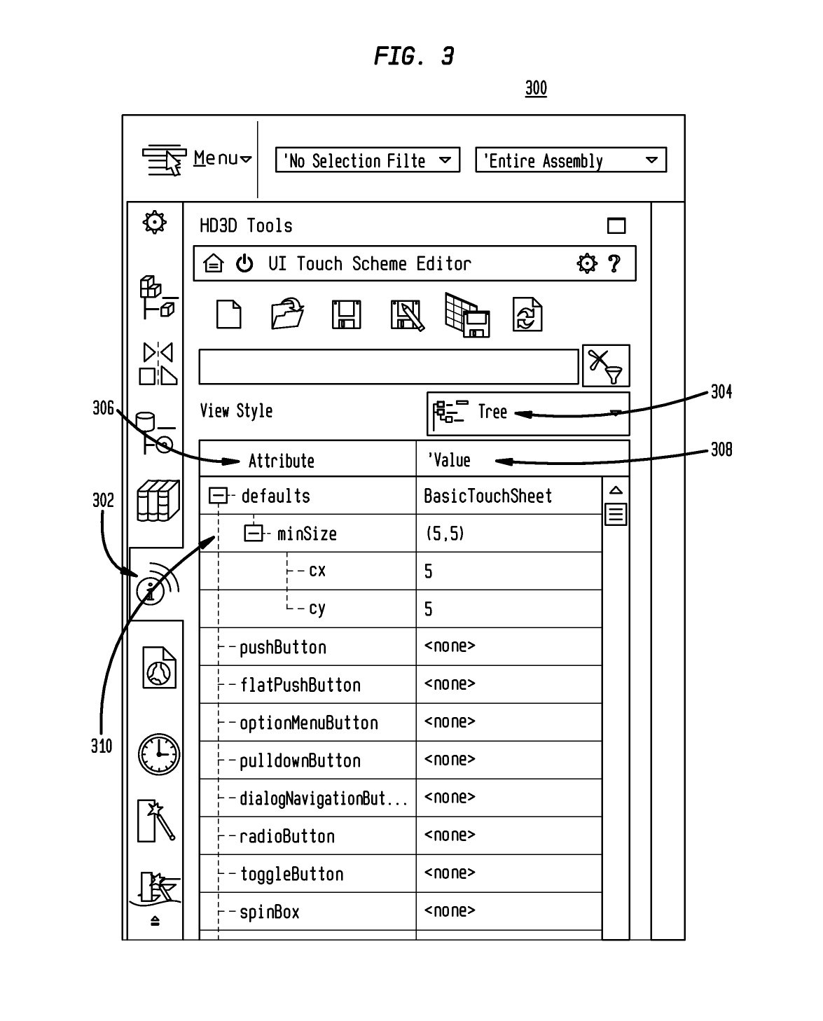

FIG. 3 illustrates an exemplary embodiment of a UI 300 that corresponds to the UI 200 illustrated in FIG. 2, but with TSX applied. As defined in the UI, the UI element 302 is displayed as a tree style 304, shown as the tree 310. Each element has one or more attributes 306, each of which may have a corresponding value 308 to form attribute/value pairs.

As can be seen, the spacing between the attributes displayed in the tree 310 is wider, after having the TSX applied, than that illustrated in FIG. 2. In particular, each of the attributes in tree 310 is shown with the defined “minSize” attribute applied, so that each entry has a minimum height (cy) and width (cx) in tree 310.

Any number of UI elements can be defined in the system, including one or more customizable attributes about said UI elements, including but not limited to margin, height, width, color, style (including but not limited to bold, italics, all caps, etc.), etc.

As illustrated in FIG. 3, a user can interact with a system for configuring attributes, such as height and width of one or more UI elements. For example, the height (cy) and width (cx) of a pushButton, flatPushButton, spinBox, radioButton, etc., can all be defined in the system to various heights and widths as illustrated in FIG. 3. The user-defined information is stored in the system, such as in an XML file, an example of which is illustrated below. A system (such as the NX software product available from Siemens Product Lifecycle Management Software Inc. (Plano, Tex.)) reads the stored information and configures each of the configurable UI elements based on the attribute settings stored therein. In such a way, each UI element can be displayed in a consistent and configurable manner independent of the platform or system being used.

```
<?xml version=“1.0” encoding=“UTF-8”?>
<NX_TOUCHSCHEME>
    <UIElement class=“BasicTouchSheet” name=“defaults”>
        <TouchSheet class=“BasicTouchSheet”>
            <minSize cx=“10” cy=“10”/>
        </TouchSheet>
    </UIElement>
    <UIElement class=“BasicTouchSheet” name=“treeListItem”>
        <TouchSheet class=“BasicTouchSheet”>
            <minSize cx=“10” cy=“10”/>
        </TouchSheet>
    </UIElement>
    <UIElement class=“BasicTouchSheet” name=“ribbonPanel”>
        <TouchSheet class=“BasicTouchSheet”>
            <minSize cx=“10” cy=“10”/>
        </TouchSheet>
    </UIElement>
</NX_TOUCHSCHEME>
```

The embodiments illustrated herein are well-tailored for reduced-size computer displays, including touch user interface environments and high density pixel display monitors, and for adjusting to meet the various needs pertaining to user accessibility (such as those with vision impairments). Information retrieved/saved from/to XML files can be modified and applied dynamically. This provides a useful means to vary the size of user-interactable elements based on the context of the interaction device and the size of the screen, rather than just blanket-increasing the size of all UI elements.

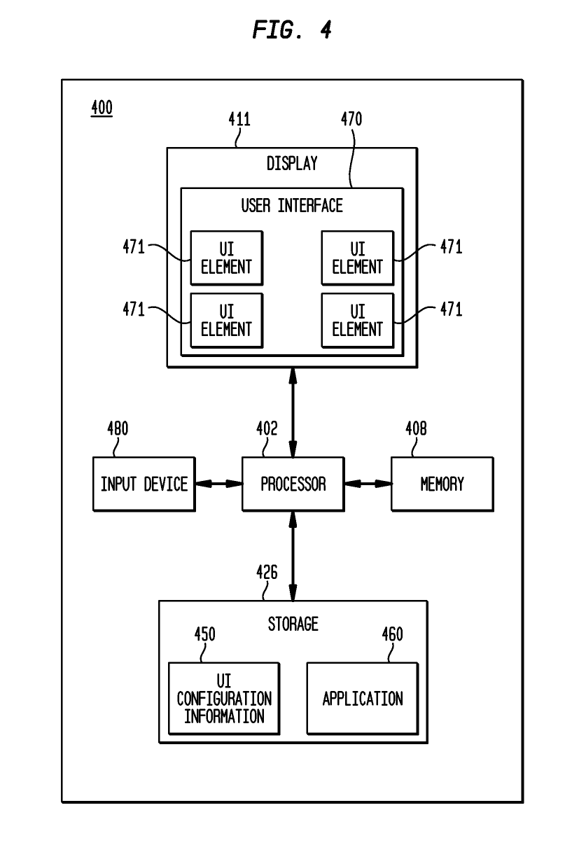

FIG. 4 illustrates some elements of a data processing system 400 that can implement disclosed embodiments, including specific elements discussed herein. Data processing system 400 can be a desktop computer system, laptop computer system, smartphone, tablet, or other mobile device, or other data processing system.

Data processing system 400 includes a processor 402 that is configured to perform the processes described herein and to access a memory 408. Processor 402 can interact with input device 480 to receive UI configuration information 450, which is stored in storage 426. Storage 426 also stores application 460 that can be executed by the processor 402.

Display 411 displays a user interface 470, for example of the application 460, which includes one or more UI elements 471. UI elements 471 can be displayed by processor 402 in user interface 470 of display 411 according to UI configuration information 450.

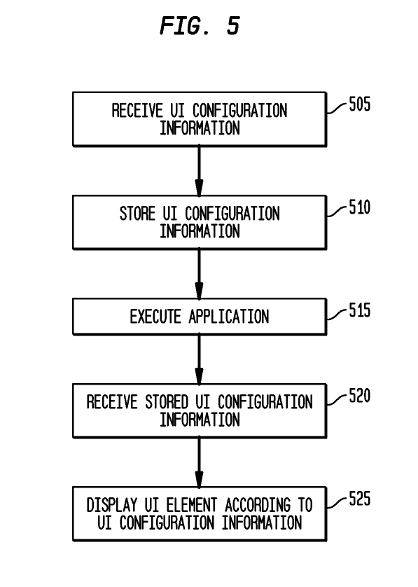

FIG. 5 depicts a flowchart of a process in accordance with disclosed embodiments that may be performed, for example, by a PLM, PDM, or other data processing system, referred to generically as the “system,” below, for adapting UI elements.

The system receives UI configuration information (505). “Receiving,” as used herein, can include loading from storage, receiving from another device or process, or receiving via an interaction with a user. In various embodiments, the UI configuration information is received via an interaction with a user via a user interface such as that illustrated in FIGS. 2 and 3. The UI configuration information defines how one or more UI elements are to be displayed by the system, can include one or more of each UI element's margin, height, width, color, style (including but not limited to bold, italics, all caps, font type, etc.), or spacing. The UI configuration information can be represented as attribute-value pairs for each of the one or more UI elements.

The system stores the UI configuration information (510). The UI configuration information can be stored, for example, as an XML file in the system's storage.

Processes 505 and 510 can be performed as many times as needed to fully configure the UI elements according to the user's preferences. Once configured, those processes need not be performed again, but can be performed again if the desired UI element appearance changes. The following processes can be performed to use the configured UI elements. In most cases, the configuration processes 505 and 510 may be performed infrequently, while the “use” processes of 515-525 are performed often.

The system executes an application (515). The application can be any application or interface that is capable of using configured UI elements as described herein, including but not limited to the NX software product.

The system receives the stored UI configuration information (520). This can include the system loading the stored UI configuration information for universal use across multiple applications, or can include the executing application loading the stored UI configuration information for its specific use.

The system displays at least one UI element in the application according to the UI configuration information (525). This can include displaying the UI element according to the UI configuration information in the single executing application, in multiple applications, or by an operating system, such as on the system “desktop.” The stored UI configuration information can be used by multiple executing applications and the resulting displayed UI elements have a common configuration when displayed by the multiple executing applications.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A method for displaying user interface (UI) elements in a data processing system, comprising:
executing an application by the data processing system;
receiving stored UI configuration information; and
displaying at least one UI element by the data processing system and in the application according to the UI configuration information.

2. The method of claim 1, wherein the data processing system also receives, via an interaction with a user, the UI configuration information and stores the UI configuration information.

3. The method of claim 1, wherein the UI configuration information defines how the at least one UI element is to be displayed by the system.

4. The method of claim 1, wherein UI configuration information includes one or more of the UI element's margin, height, width, color, style, or spacing.

5. The method of claim 1, wherein the UI configuration information is represented as attribute-value pairs for each of the at least one UI elements.

6. The method of claim 1, wherein the UI configuration information is stored as an XML file in a data processing system storage.

7. The method of claim 1, wherein the stored UI configuration information is used by multiple executing applications and the displayed UI elements have a common configuration across the multiple executing applications.

8. A data processing system comprising:
a processor; and
an accessible memory, the data processing system particularly configured to
execute an application;
receive stored UI configuration information; and
display at least one UI element in the application according to the UI configuration information.

9. The data processing system of claim 8, wherein the data processing system also receives, via an interaction with a user, the UI configuration information and stores the UI configuration information.

10. The data processing system of claim 8, wherein the UI configuration information defines how the at least one UI element is to be displayed by the system.

11. The data processing system of claim 8, wherein UI configuration information includes one or more of the UI element's margin, height, width, color, style, or spacing.

12. The data processing system of claim 8, wherein the UI configuration information is represented as attribute-value pairs for each of the at least one UI elements.

13. The data processing system of claim 8, wherein the UI configuration information is stored as an XML file in a data processing system storage.

14. The data processing system of claim 8, wherein the stored UI configuration information is used by multiple executing applications and the displayed UI elements have a common configuration across the multiple executing applications.

15. A non-transitory computer-readable medium encoded with executable instructions that, when executed, cause one or more data processing systems to:
execute an application;
receive stored UI configuration information; and
display at least one UI element in the application according to the UI configuration information.

16. The computer-readable medium of claim 15, wherein the data processing system also receives, via an interaction with a user, the UI configuration information and stores the UI configuration information.

17. The computer-readable medium of claim 15, wherein the UI configuration information defines how the at least one UI element is to be displayed by the system.

18. The computer-readable medium of claim 15, wherein UI configuration information includes one or more of the UI element's margin, height, width, color, style, or spacing.

19. The computer-readable medium of claim 15, wherein the UI configuration information is represented as attribute-value pairs for each of the at least one UI elements.

20. The computer-readable medium of claim 15, wherein the UI configuration information is stored as an XML file in a data processing system storage.
